(19) United States
(12) Patent Application Publication
(10) Pub. No.: US 2003/0074326 A1
(43) Pub. Date: Apr. 17, 2003

(54) Method and apparatus for providing biometric information as a signature to a contract

(76) Inventor: James T. Byers, The Woodlands, TX (US)

Correspondence Address: Terry D. Morgan, Williams, Morgan & Amerson, P.C., Suite 250, 7676 Hillmont, Houston, TX, 77040, US

(21) Appl. No.: 10/274,014

(22) Filed: Oct. 17, 2002

Related U.S. Application Data
(63) Continuation-in-part of application No. 09/982,385, filed on Oct. 17, 2001.

(51) Int. Cl. G06F 17/60

(52) U.S. Cl. 705/64

(57) ABSTRACT

A method and an apparatus are provided for allowing biometric information to be used as a signature to an electronic contract. The method comprises: obtaining an electronic version of a contract, and obtaining biometric information from at least one party to the contract. Thereafter, the biometric information is associated with the contract to uniquely identify the party to the contract. The apparatus is comprised of an electronic contract and a device adapted for obtaining biometric information from a party to the electronic contract. The apparatus also includes a device for associating the biometric information with the electronic contract.

### BACKGROUND OF THE INVENTION

1. Field of the Invention

This invention relates generally to the use of digital signatures on a contract, and, more particularly, to recording biometric information as the signature to the contract.

2. Description of the Related Art

On Jun. 30, 2000, President Clinton signed into law the Electronic Signatures In Global and National Commerce Act (E-SIGN Act), which became effective in the United States on Oct. 1, 2000. The E-SIGN Act implements a national uniform standard for all electronic transactions that encourages the use of electronic signatures and electronic contracts by providing legal certainty for these instruments when signatories comply with its standards. The E-SIGN Act is, however, technology-neutral, neither requiring nor recommending a specific type or method that businesses and consumers must use or accept to create and sign an electronic contract.

Due to the fact that the E-SIGN Act is technology-neutral, a number of technical methodologies for obtaining the digital signature have been suggested. These methodologies, however, have proven to be inadequate for various reasons. For example, the proposed methodologies may be subject to noteworthy security shortcomings, allowing them to be the subject of significant incidents of fraud and theft. Prior methods for providing electronic signatures have been based on devices such as card keys, “smart cards”, and X.509 digital certificates. These and other methods have the disadvantage of being capable of duplication or theft. Owing to their susceptibility of theft and fraud, the industry has put in place a set of rules for limiting the liability of the consumer. For example, if a person reports that their credit card was stolen, that person may be liable for only a portion of any fraudulent charges. In like manner, a contract signatory who claims that their smart card was stolen, or that their laptop computer containing their X.509 digital certificate was stolen, has limited liability for any contract signatures made after the theft. Nevertheless, whether the consumer is directly shielded from these losses, at least some of the funds may never be recovered, increasing the cost of doing business, which is ultimately born by the consumer.

Additionally, the proposed methodologies are not easily understood by the non-technical business and legal communities, and, thus, wide acceptance of their use may be resisted. In fact, none of the proposed methods has been accepted by the legal community as uniquely identifying an individual. The concepts and principles behind current methods for electronic signatures are complex, and often, parties to a contract lack sufficient technical proficiency to understand the principles, and may, in fact, be incapable of distinguishing one person's digital signature from another. For example, consider the following computer industry definition:

To facilitate authentication, a digital signature is a cryptographic function computed as a message and a user's private key. The private key is a number or a mathematical value that is unique to the sender. The signature function produces a value unique to the private key and the fingerprint value being signed. The private key has a mathematically related public key that anyone may use to verify the signature created by the private key.

Excerpt from U.S. Pat. No. 6,298,445.

Use of such a digital signature and private key may require a computer expert to resolve every legal dispute involving a party's denial of signature. The expense and difficulty in explaining the principles and concepts of digital signatures to the non-technical hinder the acceptance of electronic contracts with electronic signatures.

The present invention is directed to overcoming, or at least reducing the effects of, one or more of the problems set forth above.

### SUMMARY OF THE INVENTION

In one embodiment of the present invention, a method is provided. The method is comprised of obtaining an electronic version of a contract and obtaining biometric information from at least one party to the contract. Thereafter; the biometric information is associated with the contract to uniquely identify the party to the contract.

In another embodiment of the present invention, an apparatus is provided. The apparatus is comprised of an electronic contract and a device adapted for obtaining biometric information from a party to the electronic contract. The apparatus also includes a device for associating the biometric information with the electronic contract.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a top-level diagram of one embodiment of a hardware system on which the present invention may be implemented;

FIG. 2 illustrates a flow diagram of a software component that may be employed in the hardware system of FIG. 1 to support the use of a scanned and digitized human fingerprint to be acquired, stored and available for use in providing an electronic signature;

FIG. 3 illustrates a flow diagram of software component processes and repositories that may be employed in the hardware system of FIG. 1 to acquire a scanned and digitized human fingerprint for either signatory registration, or for electronically signing a contract; and

FIG. 4 illustrates an overall process used to create, approve, and sign electronic contracts with electronic signatures using a scanned and digitized human fingerprint.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

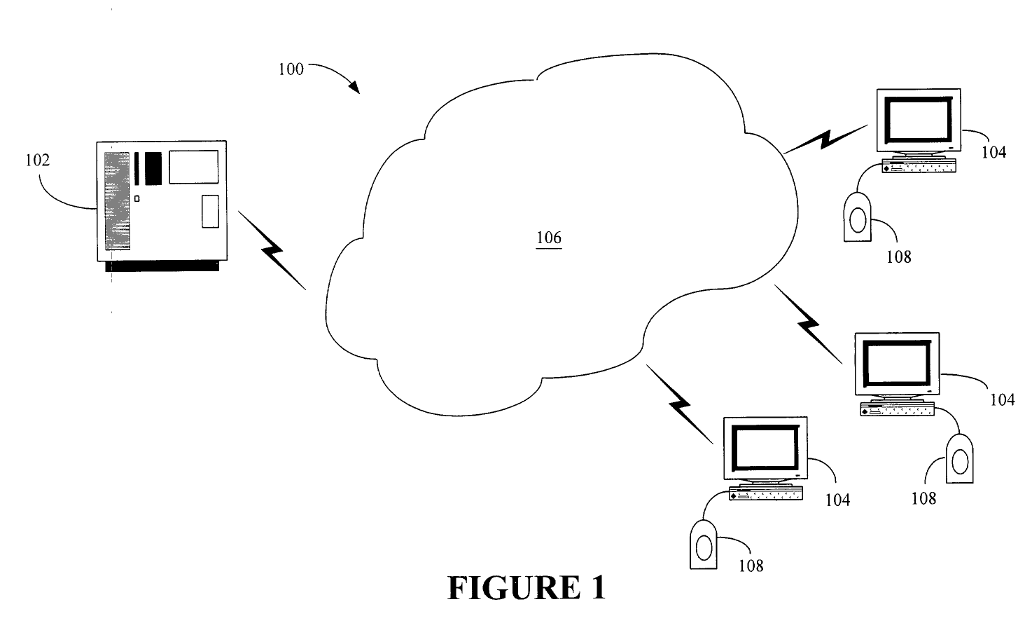

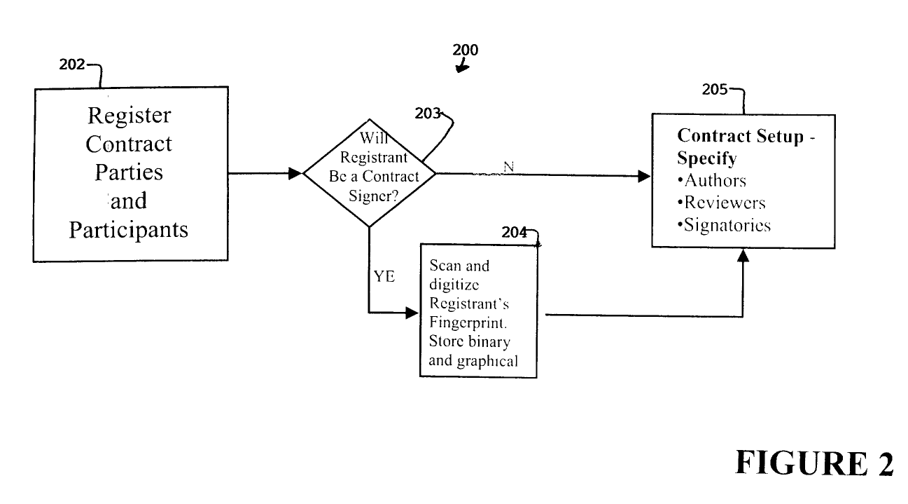

Turning now to the drawings, and specifically referring to FIG. 1, a block diagram of a system 100 is illustrated, in accordance with one embodiment of the present invention. The system 100 may be generally used to prepare, sign, store and retrieve a variety of contracts in electronic form. In addition to these general functions, the system 100 may be programmed to perform additional functions that are subsets of or related to the general functions, as described more thoroughly below in reference to FIGS. 2-4. The system 100 may be comprised of a server 102 that may take the form of any of a variety of conventional computing devices, such as those widely available from Dell, Compaq, Hewlett-Packard, Sun Microsystems, IBM, Apple and the like. Those skilled in the art will appreciate that while the embodiment shown in FIG. 1 illustrates a single computing device forming the server 102, the functions attributed to the server 102 may be distributed over one or more devices, which may operate cooperatively to provide the functions described below and attributed to the server 102 in reference to FIGS. 2-4.

One or more computing devices 104, such as personal computers, desktop computers, laptop computers, personal data assistants, and the like, may be coupled to the server 102 through any of a variety of conventional networks 106, such as an intranet, internet, the World Wide Web, any public or private data network, or the like. The connection to the network 106 may be of any type or combination of types, including but not limited to telephonic, hard-wired, wireless, twisted pair, coaxial, and may include routers, switches, hubs, modems and the like.

Generally, the computing devices 104 may be used to retrieve biometric information from one or more signatories of a contract and then associate the biometric information with the contract and transfer the information to the server 102. Those skilled in the art will appreciate that while the embodiment shown in FIG. 1 illustrates the server 102 and the computing devices 104 as separate devices, the functions attributed to the server 102 and the computing devices 104 may be performed in a single device, which may operate to provide the functions described below and attributed to the server 102 and the computing device 104 in reference to FIGS. 2-4. Alternatively, one or more of the functions attributed to the server 102 may be distributed to the computing device(s) 104, which may operate cooperatively to provide the overall function of system 100.

Each of the computing devices 104 has associated with it, a device 108 capable of collecting a biometric sample from the designated signatory. The biometric sample may take the form of one or more fingerprints, palm prints, retina scans, iris scans, DNA samples, voice prints, face scans, or other physical attribute relatively uniquely associated with a person. The biometric sample is digitized and stored electronically with the contract, serving as the signature of the party. The biometric sampling device 108 may take the form of one or more of any of a variety of devices, but in the illustrated embodiment is a biometric application programming interface (bioAPI) consortium compliant fingerprint scanning device, such as an Ethentica MS 3000 PC Card or USB 2500 devices.

After digitally signing the contract, the contract along with its attendant digital signatures is stored on the server 102, from where they may be retrieved for a variety of future uses.

The function and operation of the server 102 and computing devices 104 are controlled by software. Generally, the server 102 employs any conventional operating system, a conventional data base manager, such as those available from Domino, Oracle, Sequel Server, Informax, Microsoft and the like, and software that populates, retrieves and encrypts data stored in the data base manager. Typically, the data base manager software will maintain two data bases, one for storing the contracts and digital signatures, and one for storing personal information and biometric information (such as fingerprints) regarding registrants or parties to the contract.

The computing device 104 generally employs any conventional operating system, any conventional browser, such as Internet Explorer, Navigator, and the like, and a software module for operating the device 108 to retrieve the biometric information. The browser is commonly used to access the server 102 over the network 106.

Turning now to FIG. 2, a flow diagram depicting functions associated with system administration 200 is illustrated. Generally, system administration is a set of computer software component processes that administer and maintain the electronic contract database and the electronic signature database. In the illustrated embodiment, the system administration software 200 is located on and executed by the server 102. However, the instant invention is not so limited, but rather, admits to wider application. That is, the system administration software 200 may be implemented partially or totally on the computing devices 104.

At block 202, the computer software component process for adding system users is illustrated. The users-are categorized as either a party to the contract or as participants to the contract negotiations. A participant is one who contributes to the contract negotiations, and so must be given access to the electronic contract, addendums, and revisions. A participant might be one that authors and revises the electronic contract, addendums and attachments, or might be one that only reviews and provides feedback during the negotiations. A participant, however, is not one who will be held liable to the terms of the contract, and so will be registered to be assigned a User ID, password, and, perhaps, digital certificate for encryption and security purposes, but will not require the scanning and digitizing of a fingerprint. A party to the contract is one who, in addition to participating in the contract negotiations, will also be held liable for the terms of the contract when signed. Consequently, a contract party, as a signatory authority, must, in addition to the normal registration process, provide a scanned and digitized human fingerprint. The process of registration may be accomplished at the physical location of the server 102 or at any of the computing devices 104.

At block 203, the system administration software determines if the registrant for the electronic contract negotiations will be a participant and signatory authority, or only a participant. In the event that the registrant is both a participant and a signatory authority, control transfers to block 204. To support an electronic signature with this invention, the signatory authority's finger is scanned using the fingerprint scanner 108 attached to the registrant's computing device 104. The registrant's fingerprint is scanned, the quality of the scan is verified, and the minutiae points necessary for fingerprint analysis are captured. These minutiae points are stored as binary data in the Registrant Database for later retrieval and signatory verification. In one embodiment, a graphical representation is also constructed from the binary data, which representation will match the registrant's own fingerprint, for purposes of providing the users with a visual verification of what is stored as binary data.

Thereafter, or in the event that the registrant has not been identified as a contract signer in block 203, control transfers to block 205 to process all registrants: participants and, signatory authorities. Each registrant must be categorized as an Author, who is able to create and edit the electronic contract and its addendums and attachments; a Reviewer, who is able to view all of the electronic contract, and can provide feedback to all of the participants for that electronic contract, but who cannot make any revisions to the electronic contract; and a Signatory, who is able to electronically sign, and thereby seal, the electronic contract. A registrant can be any combination of these three-roles.

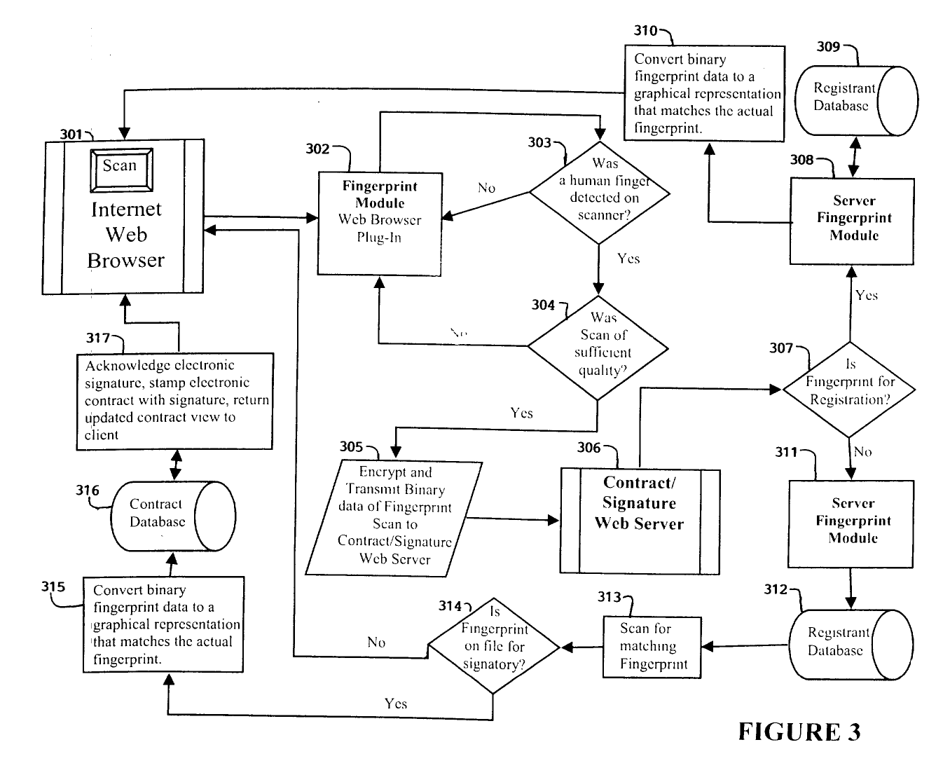

Turning now to FIG. 3, a flowchart depicting the operation of the server 102 and computing device 104 during a “signing” or registration incident is illustrated. Beginning at block 301, an interface with the contract participants is illustrated. In particular, the web pages of the server 102 are displayed for the electronic contract participants through an internet web browser. The web pages present the participant with a method whereby the participant can navigate the invention's electronic contract repository and can view exact visual representations of the electronic contract and its addendums and attachments. The “Scan” button in block 301 represents an icon that may be clicked or otherwise actuated by the signatory participant to initiate a scan of the signatory's fingerprint for either registration or for providing an electronic signature to the electronic contract.

At block 302, the fingerprint module, which is computer software component that is available on the participant's computing device 104 as, for example, a plug-in to the participant's Internet Web Browser. A plug-in is computer software component that provides special functionality that is not ordinarily available with an Internet Web Browser. The fingerprint module is written to work with any fingerprint scanning device that is BioAPI compliant.

The fingerprint module passes software control to block 303 where it, for purposes of avoiding potential acts of fraud, determines if a human finger is detected on the scanner 108. The above-identified bioAPI compliant devices are capable of accurately determining if actual and live human skin has been placed on the scanner by, for example, testing the conductivity of the material placed on the scanner 108. If a live human finger has not been detected, then software control returns to block 302. On the other hand, if a live human finger is detected, then software control proceeds to block 304.

At block 304, the fingerprint module determines if the fingerprint scan was of sufficient quality as to provide a verifiable and unique identification of the person's fingerprint. If not, then the invention returns software control to block 302 for a re-scan. If the scan is of sufficient quality, then software control proceeds to block 305.

At block 305, an industry standard high-level encryption is applied to the binary data captured by the fingerprint scan device 108. The encrypted binary data is then transmitted to the Server 102. The fingerprint module in the participant's web browser plug-in is used to capture the binary data necessary for fingerprint analysis, but no fingerprint verification is performed in the participant's Web Browser or on the participant's computing device 104. This is to be performed on the invention's remote servers, so that minimal data is transmitted over the internet, thereby insuring security and efficiency.

Block 306 represents the Contract/Signature portion of the server 102 that communicates directly with the web browser in the computing device 104. The server 102 may consist of one or more servers, possibly clustered, as the processing demands require. The server 102 is responsible for the encryption and decryption of data with the participant's web browser, is responsible for basic and digital verification of the participant's identification, and is responsible for directing the participant's information requests to the appropriate back-end processes, as needed.

At block 307, the server 102 determines if the fingerprint scan was for purposes of registration or not. If the fingerprint scan was for registration, then software control proceeds to block 308. If not, then the scan was performed to electronically sign an electronic contract, in which case software control proceeds to block 311.

At block 308, the server fingerprint module is accessed. The server fingerprint module is not necessarily the same device as the server 102, but can be the same computer. The server fingerprint module analyzes the binary data sent by the web browser plug-in fingerprint scan to extract the fingerprint minutiae points and other relevant information. The extracted data is then placed in the Registrant Database in block 309, along with all other identifying information relevant to the registrant, who in this case is a signatory authority. If block 309 is successful, then software control proceeds from block 308 to block 310.

Block 309 represents the registrant database, which contains all identifying information pertaining to each user's identification and role in the electronic contract negotiation process. Additional information is stored therein that relates a registrant to the electronic contract(s) to which the registrant is a participant. This database is highly secure and can only be accessed by server processes. No other direct access is permitted. When accessed by server processes, the Registrant Database returns a success or fail status to block 308.

At block 310, the process that converts the now registered fingerprint scan into a visual graphical representation that directly matches the registrant's own human fingerprint is shown. This graphical data is returned to the registrant's web browser at block 301 and is viewable within at the computing device 104. This allows the registrant to visually verify that the registrant's fingerprint was successfully processed.

In the event that the process identified in block 307 determines that the fingerprint scan was not for purposes of registration, then software control is transferred to block 311, which represents the Fingerprint Module. This is a computer process that passes the binary fingerprint scan data to the Registrant Database at block 312, along with other identifying information, for verification. The Registrant Database contains the server processes used to support the electronic signature.

At block 313, the process determines if a given set of binary fingerprint scan data has a match in the set of currently registered electronic contract participants. The algorithm for matching binary fingerprint scan data is in accordance with the industry standards set by the Biometric Consortium.

Thereafter, at block 314 a signal or message regarding whether the electronic contract participant's fingerprint is on file and is registered as a signatory authority is produced. If the participant is not a signatory authority, then a message so indicating is returned to block 301. If the participant is authorized to electronically sign the electronic contract, then software control proceeds to block 315.

At block 315, the binary fingerprint scan data is converted into a graphical representation that directly matches the registrant's own human fingerprint. This graphical data is returned to the registrant's web browser and is viewable on the computing device 104. This allows the registrant to visually verify that the registrant's fingerprint was successfully processed by the invention.

At block 316, the Contract Database, which contains all electronic contracts, each contract's addendums, attachments, and all other information relevant to the electronic contract negotiations, revisions, and signing is accessed.

At block 317, the now verified binary fingerprint scan data is attached to the electronic contract, and the electronic contract is flagged as duly signed. An updated web page is returned to the participant's web browser, showing the electronically signed contract.

Block 301 represents the processes and interfaces to allow the system administrator to administer all of the databases and user information. A significant part of this process is the categorization of electronic contract participants as Author, Review, and/or Signatory. Additional human steps might need to be performed by the System Administrator or designate to verify information provided during the registration process or to provide online assistance to the registrant.

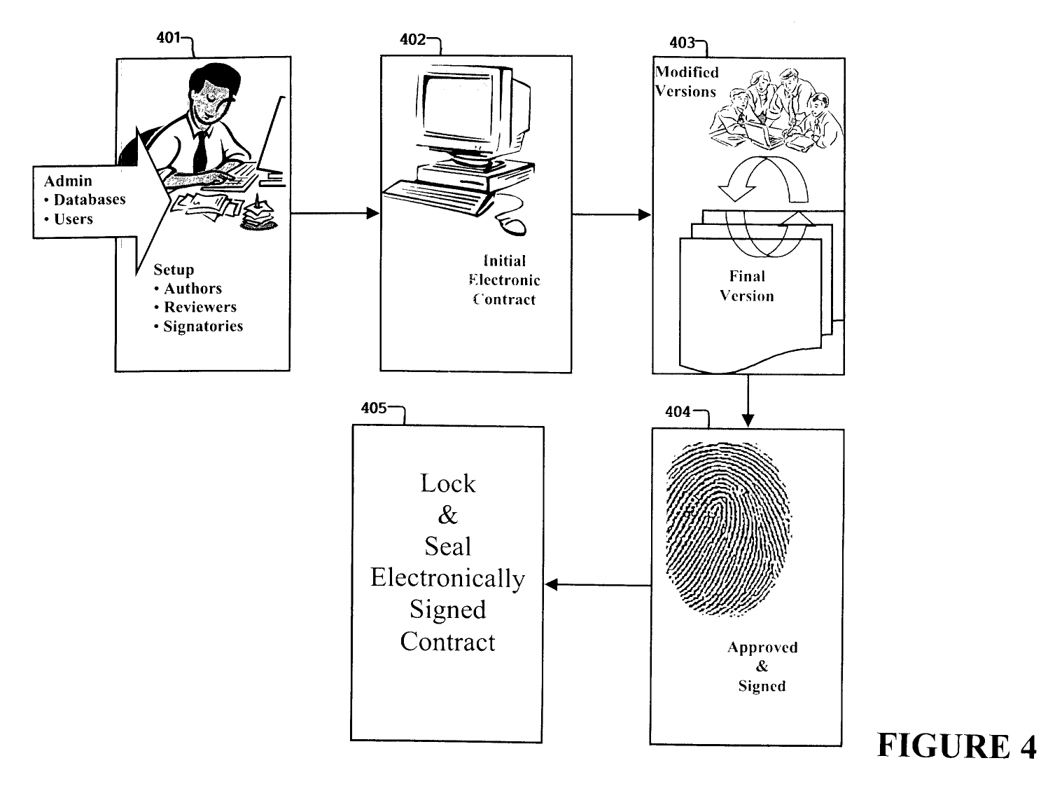

Turning now to FIG. 4, an overview of the process involved in preparing and electronically signing an electronic contract is illustrated. Beginning at block 401 the various parties involved in the contract, such as the authors, reviewers and signatories are identified and their personal information is collected and stored in the database. At block 402, the electronic contract is initially prepared and stored in the database. Thereafter at block 403, the electronic contract is revised and modified per the proposals and agreements of the parties. The participants are permitted to collaborate electronically via text messages, live or recorded voice messages, and live or recorded video messages and conferencing in order to remove any geographical barriers and to significantly streamline the entire contract process. The final outcome of this process is the Final Version of the electronic contract, its addendums and attachments, which is now ready for electronic signing.

At block 404, the processes that capture each signatory authority's fingerprint, processes the data as shown in FIG. 3, and notifies each participant as to the progress of the signing are shown. Finally, at block 405, the processes that lock and seal electronically signed contracts to prevent any further revisions are shown. These processes make the electronic contract and associated documents a permanent set of electronic records. Participants are electronically notified at the conclusion of the process.

Thus, it will be appreciated that the invention provides methods and processes whereby an easily understood and defensible form of electronic signature, a digitized scan of the human fingerprint, that will allow full use of the opportunities afforded by the Electronic Signatures In Global and National Commerce Act (E-SIGN Act). Without this invention, the use of electronic contracts and electronic signatures as original documents will be mired in the failings of the prior art. This invention provides methods and processes to capture and maintain data for unique identification of persons, which data is not subject to the fraud and theft of the methods contained in prior art. By legitimizing the entire process of electronic contract negotiations, this invention allows a significant and often critical reduction in the effort and time necessary in completing contract negotiations. The geographic boundaries between contract parties are removed by this invention's facilities to support electronic collaboration, information gathering and recording, and electronic signing. With this invention, the entire process of contract drafting, revising, finalizing, and signing remove all need of any of the parties or participants to ever be in the same room. This invention allows its users to continue with their other business and personal interests without interruption and without the costs associated with geographical meetings. Due to its fully electronic nature in the business of contracts, use of this invention will allow a multitude of businesses to expand beyond their geographical boundaries, since all business transactions start with a contract. With this invention, the use of contracts will be limited only by the reaches of the Internet and other mediums of computer communication. By virtue of its speed of electronic access, use of this invention will allow the sealing of business negotiations to be successful, since oftentimes any delay provides opportunity for a business deal to fail and for parties to change their mind.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
obtaining an electronic version of a contract;
obtaining biometric information from at least one party to the contract; and
associating the biometric information with the contract to uniquely identify the party to the contract.

2. A method, as set forth in claim 1, wherein associating the biometric information with the contract to uniquely identify the party to the contract further comprises attaching an electronic representation of the biometric information to the contract.

3. A method, as set forth in claim 2, wherein associating the biometric information with the contract to uniquely identify the party to the contract further comprises storing the electronic contract and the electronic representation of the biometric information in a database.

4. A method, as set forth in claim 2, wherein associating the biometric information with the contract to uniquely identify the party to the contract further comprises encoding and storing the electronic contract and the electronic representation of the biometric information in a database.

5. A method, as set forth in claim 1, wherein obtaining biometric information from at least one party to the contract further comprises obtaining at least one fingerprint from at least one party to the contract.

6. A method, as set forth in claim 3, wherein obtaining at least one fingerprint from at least one party to the contract further comprises obtaining an electronic representation of at least one fingerprint from at least one party to the contract.

7. An apparatus, comprising:
means for obtaining an electronic version of a contract;
means for obtaining biometric information from at least one party to the contract; and
means for associating the biometric information with the contract to uniquely identify the party to the contract.

8. An apparatus, comprising:
an electronic contract;
a device adapted for obtaining biometric information from a party to the electronic contract;
means for associating the biometric information with the electronic contract.

9. An apparatus, as set forth in claim 8, wherein the means for associating comprises a database adapted for receiving and storing the electronic contract and the biometric information.

10. An apparatus, as set forth in claim 9, further comprising an encoder adapted to encode the electronic contract and biometric information stored in the database.

11. An apparatus, as set forth in claim 9 further comprising a server adapted to store said database, and a computing device coupled to said server via a network said computing device having said device adapted for obtaining biometric information coupled thereto.

12. An apparatus, as set forth in claim 11, wherein said server and said computing device are remotely located relative to each other.

13. An apparatus, as set forth in claim 12, wherein said network coupling together the server and the computing device is an intranet.

14. An apparatus, as set forth in claim 12, wherein said network coupling together the server and the computing device is an internet.

15. An apparatus, as set forth in claim 11, wherein the server is a web server and the computing device includes a web browser for communicating with the web server.

16. An apparatus, as set forth in claim 8, wherein the device adapted for obtaining biometric information is adapted to obtain at least one fingerprint of a party to the electronic contract.

17. An apparatus, as set forth in claim 16, wherein the device adapted for obtaining biometric information is a biometric application programming interface (bioAPI) consortium compliant device.

18. An apparatus, as set forth in claim 16, wherein the device adapted for obtaining biometric information is a biometric application programming interface (bioAPI) consortium compliant fingerprint scanning device.

19. An apparatus, as set forth in claim 11, further comprising means for comparing the biometric information to a set of stored biometric information to verify the identify of a person associated with the biometric information.

20. An apparatus, as set forth in claim 19, further comprising means for declining the signature in response to failing to verify the identity of the person associated with the biometric information.
